(19) United States
(12) Patent Application Publication
(10) Pub. No.: US 2017/0367786 A1
(43) Pub. Date: Dec. 28, 2017

(54) Instruments and Method of Treatment for Pediatric Dental Hygiene Patients

(71) Applicant: Heidi L Halverson, Missoula, MT (US)

(72) Inventor: Heidi L Halverson, Missoula, MT (US)

(21) Appl. No.: 15/526,993

(22) PCT Filed: Nov. 11, 2016
(86) PCT No.: PCT/US16/61635

§ 371 Date: May 15, 2017

Related U.S. Application Data
(60) Provisional application No. 62/254,675, filed on Nov. 12, 2015.

(51) Int. Cl. A61C 3/00

(52) U.S. Cl. CPC A61C 3/00

(57) ABSTRACT

The pediatric dental treatment technique with accompanying tools brings infant, toddler, and young child dental hygiene into a mainstream services menu. Carefully chosen and styled tools allow for maximum safety and thus enhance efficiency of the child, clinician, parent or other assistant. The treatment technique is refined to eliminate any extraneous movements or tools. Because the hazards posed by other instruments are removed with the use of these specialized instruments, the operator is able to focus on the patient and the treatment areas. Therefore, the treatment goes more quickly which is important for a small child or infant. The preferred tools comprise a single-ended handle with a miniature tip having a dual cutting surface and a single-ended, miniature, anterior sickle scaler. The entire cleaning is completed quickly to reduce accident risks.

### CROSS-REFERENCE TO RELATED APPLICATIONS

This patent application claims priority to U.S. Provisional Patent Application Ser. No. 62/254,675, entitled “Instruments and Method of Treatment for Pediatric Dental Hygiene Patients” and filed on Nov. 12, 2015, which application is now pending. The entire disclosure of that provisional patent application is hereby incorporated by reference.

### STATEMENT REGARDING FEDERALLY SPONSORED RESEARCH OR DEVELOPMENT

Not applicable.

### INCORPORATED BY REFERENCE OF MATERIAL SUBMITTED ON A COMPACT DISC

Not applicable.

### BACKGROUND

### Field of Invention

This invention relates to pediatric dentistry and more specifically to devices and treatments used by dentists and dental hygienists when treating small children. The curettes, scalers, and treatments particularly assist professionals working in the field of dentistry when providing treatment to children between the ages of 6 months and 11 years.

### Description of Related Art

Dental instruments to remove tartar from teeth have been around for centuries. However, until recently the earliest age that children were being treated was between 3-4 years of age. Scientific studies now suggest that children are at risk for tooth decay and cavities when they first begin teething—around six months of age—because of Early Childhood Caries (ECC) and other causes. The growth of ECC and need for infant oral care is discussed in the March 2012 article by Arthur J. Nowak, DMD, MA and Paul Casamassimo, DDS, MS titled Start at Year One which appeared in the journal, Dimensions of Dental Hygiene.

Another article by Lori Rainchuso, RDH, MS titled The ABCs of Infant Oral Health and appearing in the journal, Dimensions of Dental Hygiene in October 2012 discussed these concerns. Ms. Rainchuso discusses assessing and treating an infant with a toothbrush while the parent is knee to knee with the hygienist. However, Ms. Rainchuso's focus is more on early preventative education and teaching good home-hygiene techniques.

Although education is very important, if the child has buildup (calculus) on the teeth, it may require more than a tooth brush to remove. The dental instruments used on adults and older children generally have blades on both ends and come in various, but only larger sizes.

The Gracey curette, invented by Dr. Clayton Gracey with the help of Hugo Friedman of Hu-Friedy Manufacturing company in the early 1940s, has a blade that is laterally offset by 70 degrees relative to the shank. Consequently, a Gracey curette has a lower cutting edge and an upper non-cutting edge. Because only one side of each blade can cut, Gracey curettes are site-specific. It is known that the Gracey curette will not work on distal surfaces, and vice versa. Gracey blades used for mesial surfaces of anterior teeth from the facial are only suitable for the distal surfaces of the same teeth when access is performed from the lingual. Gracey Curettes 1/2, 3/4, 5/6 are used on the anterior sextants of teeth. Gracey Curettes 7/8 and 9/10 are used on the buccal and lingual portions of posterior teeth. Gracey Curettes 11/12 and 15/16 are used on the mesial portions of posterior teeth. Gracey Curettes 13/14 and 17/18 are used on the distal portions of posterior teeth. A universal curette may treat a wider array of teeth and surfaces, but with a less effective surface. These tools are always sold as instruments having working tips on both ends.

The “Double Gracey” sold by American Eagle Instruments, Inc. has two cutting surfaces or blades, instead of the single cutting surface of the standard Gracey instruments. These instruments are always sold with a handle having cutting tips on opposing ends. These instruments are ineffective and pose a danger for the clinician, parent, and child during current treatment options for an infant or small child, who does not understand how to remain still and who may need special care provided with specialized equipment in order to complete the treatment.

While the need to provide preventative treatments to pediatric patients in a clinical setting is beginning to be recognized, clinicians are not being provided with appropriate instruments and safe treatment techniques have not been created or taught. The invention meets the needs of the industry to provide pediatric dental tools and treatment techniques.

### BRIEF SUMMARY OF THE INVENTION

The present invention comprises dental instruments and treatments for treating a small child, toddler, or infant—pediatric patient—in a clinical setting. The instruments further comprise a set of instruments to serve the needs of the dental professional. In the preferred embodiment, a set of two tools are provided. A first tool has a shortened tip and two cutting surfaces, the tip being mounted on single-ended handle. The preferred, shortened tip comprises two cutting surfaces that face opposite directions. A second tool is provided in the preferred embodiment. The second tool comprises a sickle scaler. The handle of either tool may be any handle formed to fit into a clinician's hand. Ideal handles will have ergonomic and gripping features. One preferred embodiment comprises instruments having a single working (cutting or cleaning) end affixed to the handle. The handle has only one working end and a blunt or smooth surface on the opposite end. Another preferred embodiment provides at least one instrument tip removably joined with at least one single-ended handle having one receiving end and a blunt opposing end.

The treatment techniques for an infant or young child dental patient according to the present invention comprise a series of steps to be performed by a dental professional (clinician) with the aid of a parent or an assistant. The order of the procedure may vary depending on the needs of a specific patient. The minimum steps comprise:
a patient rests in a chair or is held or secured such as in the arms of a parent or assistant,
a clinician uses a single-ended tool with a double cutting surface tip,
while situated at about 6 o'clock or through any number of angle positions relative to the patient, a clinician,
   inserts the single-ended, miniature, anterior double cutting surface tip in the patient's mouth,
   cleans or scales the lingual surfaces (“linguals”) or facial/buccal surfaces (“facials/buccals”) of the teeth,
   scales the linguals and the facials/buccals of the mandibular/maxillary anterior teeth,
   scales the linguals and the facials/buccals of the mandibular/maxillary anterior teeth using either side of the blade,
   removes the single-ended, miniature, anterior double cutting surface tip from the patient mouth,
a clinician uses a second tool such as a single-ended, miniature, sickle scaler,
with continuing situation at about 6 o'clock or through any number of angle positions relative to the patient, a clinician, further,
   inserts the single-ended, miniature, sickle scaler, into the patient mouth,
   scales interproximal areas of primary teeth using either side of the single-ended, miniature, sickle scaler,
   scales interproximal from the lingual and facial/buccal areas,
   scales between mesial surfaces (mesials) and distal surfaces (distals),
   fulcrums on one tooth and scales mesials and distals without changing fulcrum position,
   scales all maxillary anterior primary teeth both mesial and distal,
a clinician removes the single-ended, miniature, sickle scaler from the patient mouth and the patient is free to move about.

In the preferred embodiment, the tip with dual cutting aspects is comprised of a miniature, anterior tip similar to that provided by the “Double Gracey”. The tip may be permanently affixed or removably mounted on a handle at one, tip-receiving end. Either side of the blade of this dual cutting tip can be used to scale linguals or facials/buccals of the teeth. When scaling the linguals of the mandibular anterior teeth, either side of the blade can be used. When scaling the facials/buccals of the mandibular anterior teeth, either side of the blade can be used. Once a clinician inserts the tool into the patient's mouth and begins to scale, she can immediately scale the facials/buccals and then, without flipping the instrument, removing the tool, or changing positions, the clinician can scale the linguals. Since both sides of the blade have cutting edges the clinician can easily move from tooth to tooth with very little movement. Dual-sided cutting surfaces on the single-ended handle eliminate the need for tool flipping in the clinician's hand. The present technique allows the clinician to stay in one ergonomic position during scaling without shifting positions. Also, the clinician can scale all mandibular anterior primary teeth both facial and lingual while never having to remove or change scaling instruments. These procedures optimize efficiency which is important, even critical, when treating an active infant, toddler, or small child. Also, the miniature, rounded toe adapts safely and easily to the facials/buccals and linguals of primary teeth. The present technique allows the clinician to keep a lower shank parallel to a tooth surface (axis), similar to techniques employed with traditional Gracey instruments but in the unique manner called for in the present invention. By way of example and not limitation, the size of the miniature, anterior double cutting surface tip blade works for all primary teeth and is suited to work in these areas.

In the preferred embodiment, the single-ended, miniature, anterior, sickle scaler has an angled blade with a straight, flat face and two cutting edges that come to a point, also called the Jacquette Scaler according to the present invention. The tool must be formed to be actuated by a clinician working from any position or angle relative to the patient, including the front of the patient at about 6 o'clock, behind the patient at the 12 o'clock position, or any position range between those two points on either side of the patient. Ideally, the mini anterior Jacquette scaler is a #3 model. Either side of the small short blade can be used to scale interproximal areas of primary teeth, in the anterior and premolar areas. The clinician can also scale between mesial and distal surfaces even though the instrument is single-ended. The clinician can fulcrum on one tooth and be able to scale mesials and distals without changing his or her fulcrum. The short, small blade can be used quickly in tight contact areas of the mandibular or maxillary and anterior or posterior areas. The size of the mini, anterior, Jacquette Scaler blade works for all primary teeth. Posterior teeth in infants and young children are easy to access and the mini anterior sickle scaler works ideally. The instrument can be used for all children with primary teeth. The clinician can scale all maxillary anterior primary teeth both mesial and distal while never having to remove or change instruments. There is no flipping of a single-ended dental hygiene instrument, so it makes for faster scaling which is needed for infants and young children. The mandatory safety aspects of the single ended instrument are enhanced by the single engagement of a tool which reduces accident frequency.

Scaling posterior teeth in infants and young children is similar to scaling anterior primary teeth with the miniature, single-ended, dual cutting tip of the present invention. Using the present invention to scale all posterior primary teeth can be completed by moving the instrument from tooth to tooth with little change in angulation. Since primary teeth are smaller and have many open contacts, the present invention, particularly when using the mini, anterior, double cutting surface tip, can be used to scale all surfaces of the tooth including mesials, distals, linguals, and facials/buccals. The clinician can fulcrum on one tooth and be able to scale linguals, facials, mesials, and distals without changing his or her fulcrum.

The clinical technique of the present invention permits many advantages because it calls for the use of a specialized set of single-ended, miniature instruments vital for use on infants and young children. The enhanced safety aspects of the single-ended, miniature instrument is paramount for pediatric patients, particularly infants and young children. The absence of double-tipped handle with an opposing cutting end on the instrument provides vital safety considerations during the treatment. With only one working end to the dental hygiene instrument, the patient will not stab himself with an opposing tip. The shorter handle, attributable to the provision of only one working end instead of two working ends, makes it is less likely the patient will grab the instrument and injure himself, or his parent, hygienist, dentist or assistant, thereby reducing risk, worry, and stress to all involved. The person holding the infant or child will not get hurt by accidentally having the instrument too close to their face. The clinician does not have to worry about the infant or child grabbing a sharp, opposing tip on the other end of an instrument. The clinician does not have to worry about the adult who is holding the infant or child getting too close to a sharp opposing tip of a typical dental hygiene instrument.

With only one end of the instrument equipped for scaling the teeth, efficiency is optimized. The clinician need not guess which end to use. With only one cutting end to use the clinician can be quick at scaling the infant or young child's teeth since there are less choices. No time is wasted removing and/or flipping the instrument. The present invention meets the need of increased speed which is sometimes important when scaling a young child's teeth.

### BRIEF DESCRIPTION OF THE DRAWINGS

The following drawings further describe by illustration, the advantages and objects of the present invention. The subject matter of the drawings is hereby incorporated by reference in its entirety into this disclosure. Each drawing is referenced by corresponding figure reference characters within the “DETAILED DESCRIPTION OF THE INVENTION” section to follow.

FIG. 1 is a first side view of a first dental instrument of the present invention.

FIG. 2 is a front view of FIG. 1.

FIG. 3 is a second, side view of FIG. 1.

FIG. 4 is a back perspective view of FIG. 1.

FIG. 5 is a tip end perspective view of a dual cutting tip portion of the present invention.

FIG. 6 is an end perspective view of the blunt, handle of each dental instrument provided in the set of instruments according to the present invention.

FIG. 7 is a front perspective view of a dual cutting tip portion of the present invention.

FIG. 8 is a back perspective view of the dual cutting tip and grip portion of the present invention.

FIG. 9 is a perspective view of a dual cutting tip portion of the present invention.

FIG. 10 is a perspective view of a second instrument according to the present invention and as specified for use with the technique of the present invention.

FIG. 11 is a first side perspective view of the instrument in FIG. 10.

FIG. 12 is a front perspective view of the instrument in FIG. 10.

FIG. 13 is a second side perspective view of the instrument in FIG. 10.

FIG. 14 is a back perspective view of the instrument in FIG. 10.

FIG. 15 is a flow chart summarizing the methods of using the instruments of the present invention.

### DETAILED DESCRIPTION OF THE INVENTION

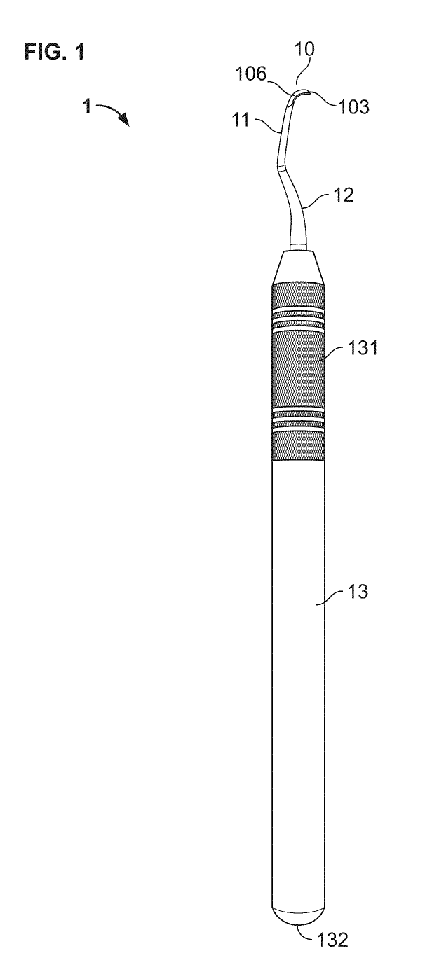

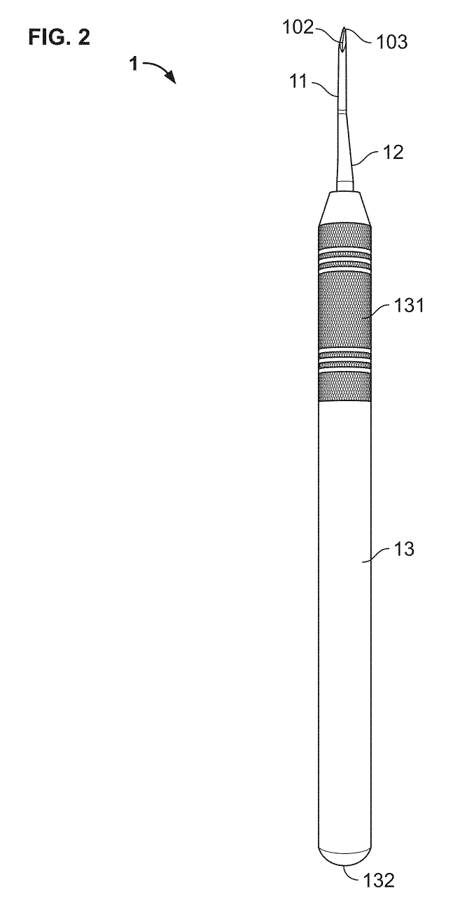

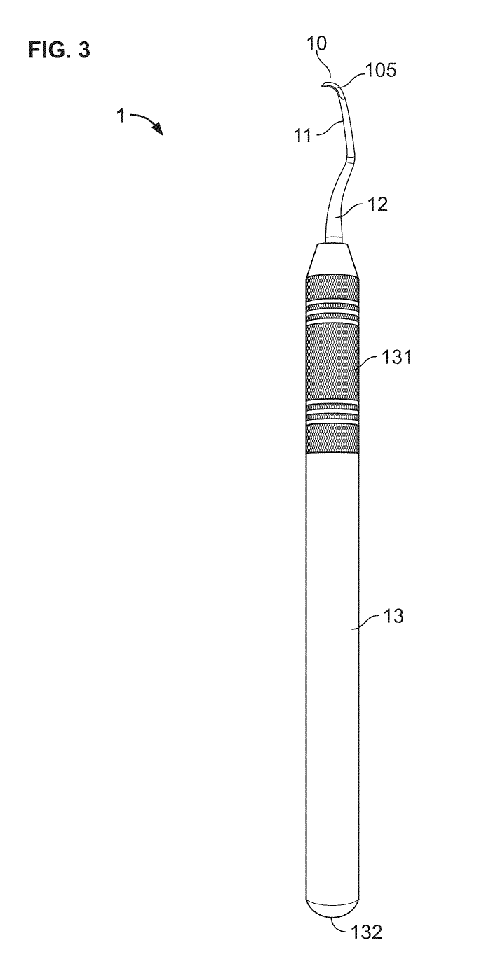

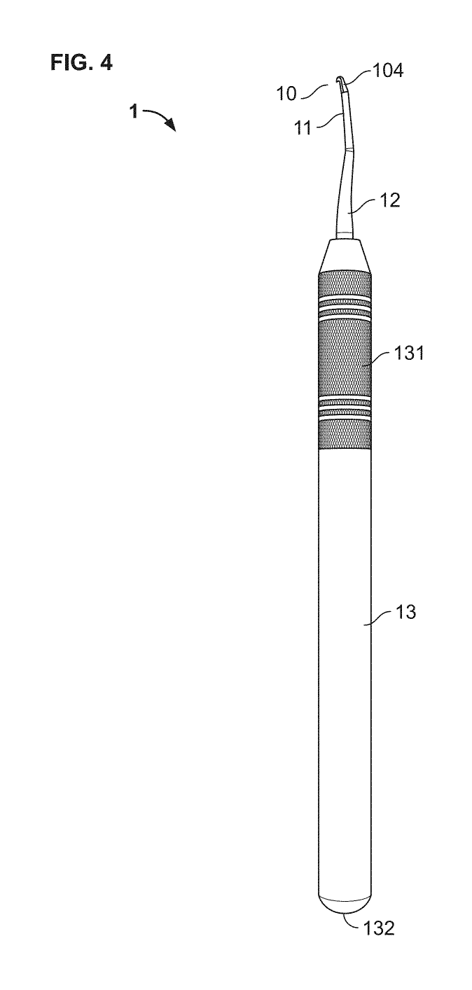

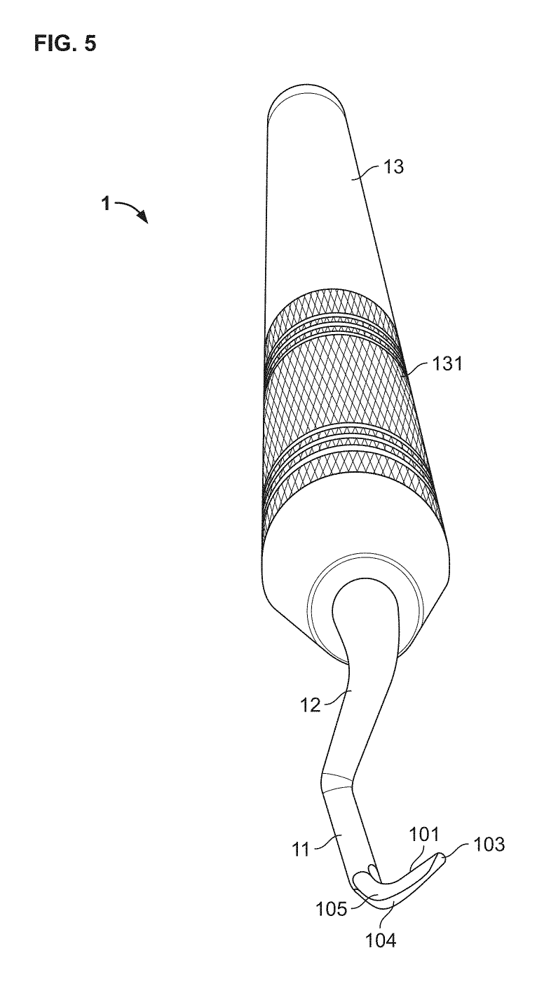

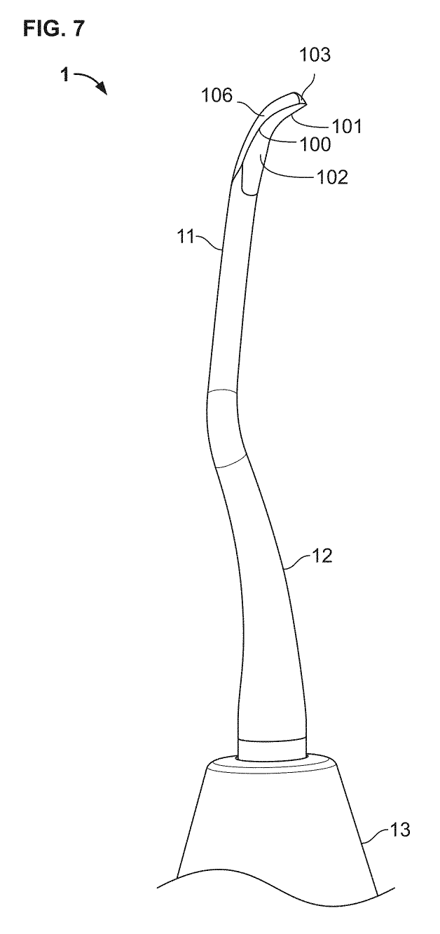

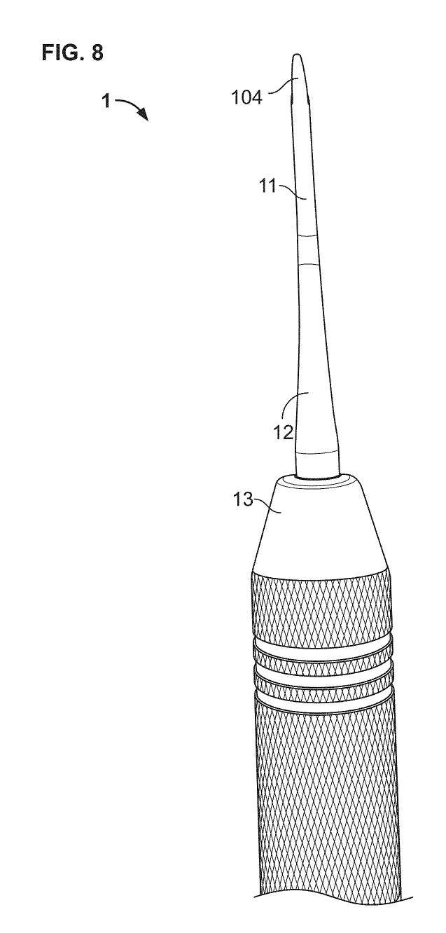

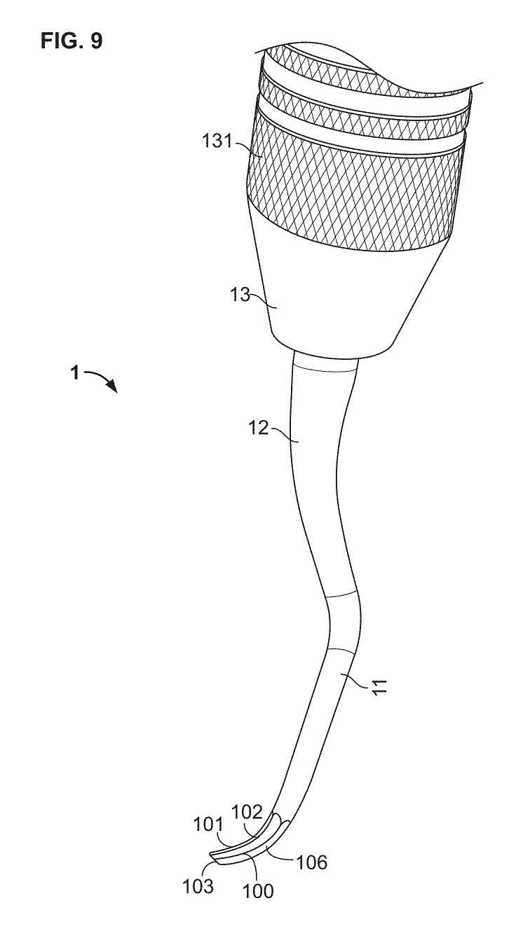

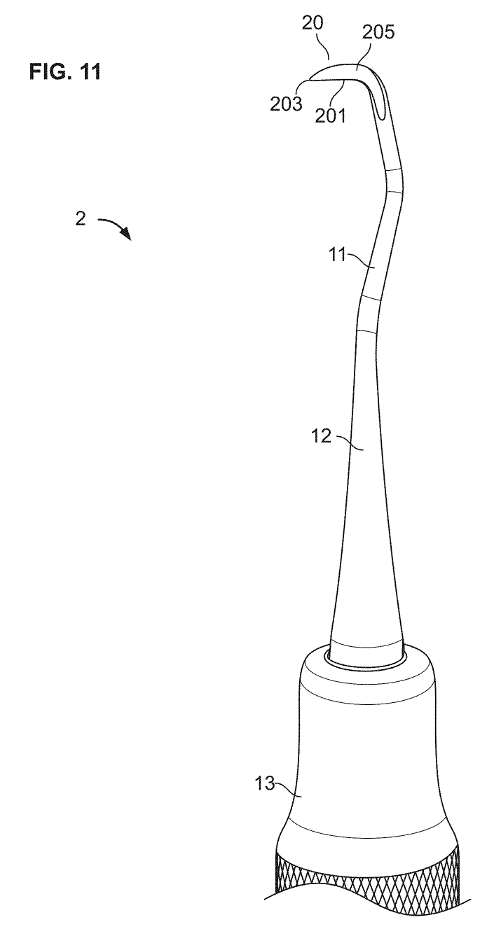

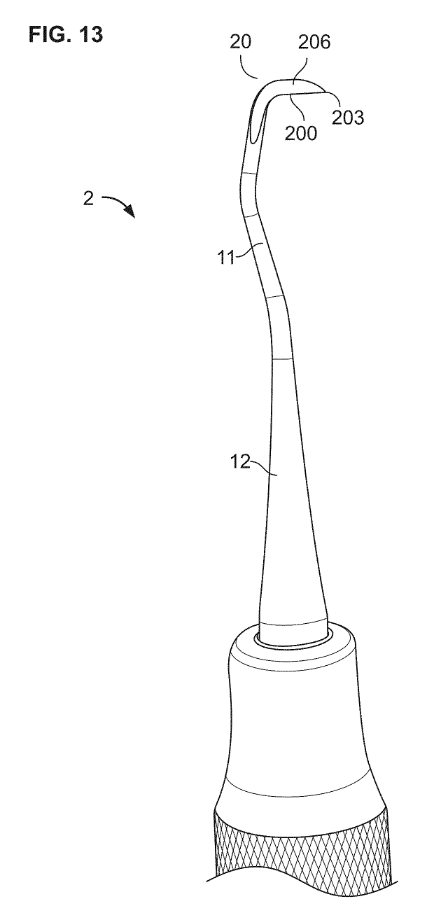

The pediatric dental instruments according to the preferred embodiment and as employed in the associated treatment for pediatric patients are illustrated in FIGS. 1-15. FIGS. 1-9 are drawings of a first tool 1 incorporating a single, specialized tip having two cutting surfaces, or edges. The cleaning surfaces for a first tool 1 comprise a cleaning blade portion 10 having two cutting edges 100, 101, two cutting surfaces 105,106, and a face 102 opposite of a back 104. The features of the first tool 1 are illustrated in FIG. 1-5 and in more detail in 7-9. With reference to FIGS. 5 and 7, a first cutting surface has a first cutting edge 100, and a second cutting surface has a second cutting edge 101. In FIG. 7, the face 102 is shown extending with a first lateral surface 105, and a second lateral surface 106 to terminate in a toe 103.

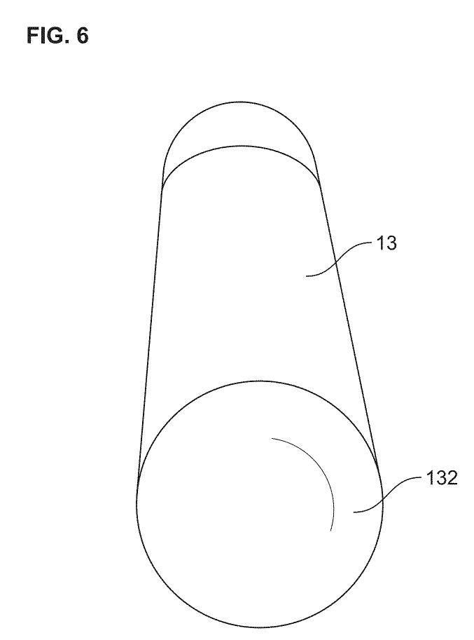

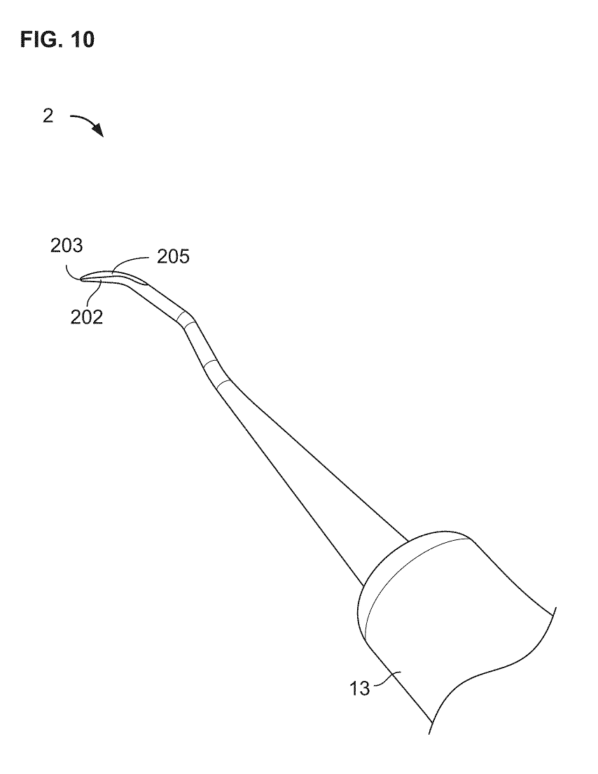

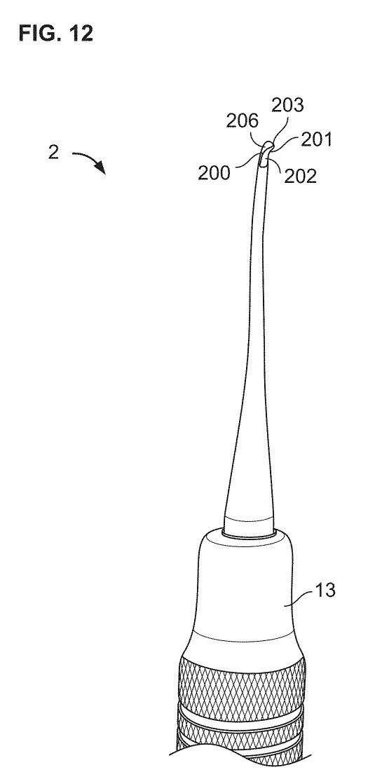

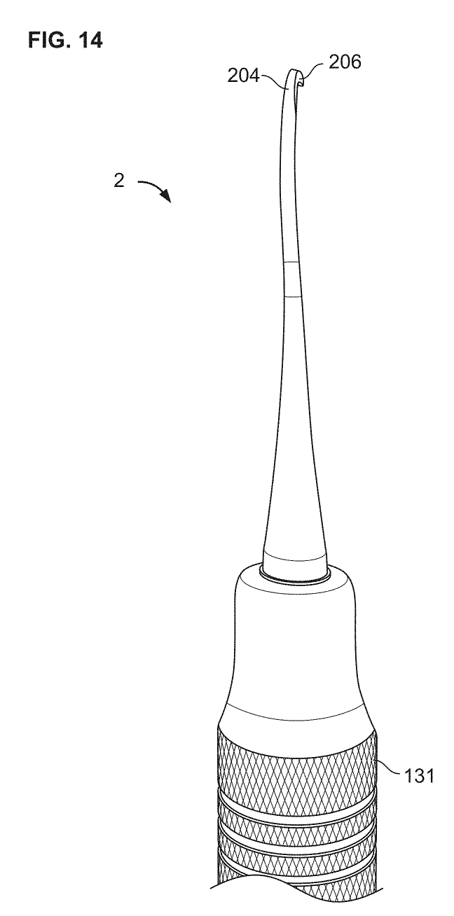

FIGS. 10-14 show details of the second tool 2 and the blunt-handle end is the same as the handle shown in FIG. 6. Referring to FIGS. 10-14, the second tool 2 comprises a scaling blade portion 20 having two scaling edges on either side of a sickle-shaped tip 203. A review of FIG. 12 shows the second tool 2 having a first scaling edge 200 opposing a second scaling edge 201 and a sickle face 202 opposite a sickle back 204 (see FIG. 14) extending with a first lateral sickle surface 205 shown in FIG. 10 and a second lateral sickle surface 206 shown in FIG. 12 to terminate in the tip 203.

Referring generally to FIGS. 1-5, the overall configuration displayed would be true for each instrument of the present invention. Meaning, the working tool end of each instrument of the present invention is either permanently mounted or removably joined with a single-ended, specialized handle 13. The respective working tip extends from the handle 13 first from a lateral shank 12 and then an upper shank 11. The handle 13 of each of the pediatric dental instruments has a grip 131 and an end 132. The end 132 of the handle does not have a working tip. It also does not engage a working tip. The blunt surface of the end 132 enhances the safety features of the instrument and the implementation techniques of the present invention. In the preferred embodiment of the present invention each of the lateral shank 12 and the upper shank 11 may be formed to be shorter than an adult-sized instrument in order to accommodate a pediatric patient mouth size and for added safety.

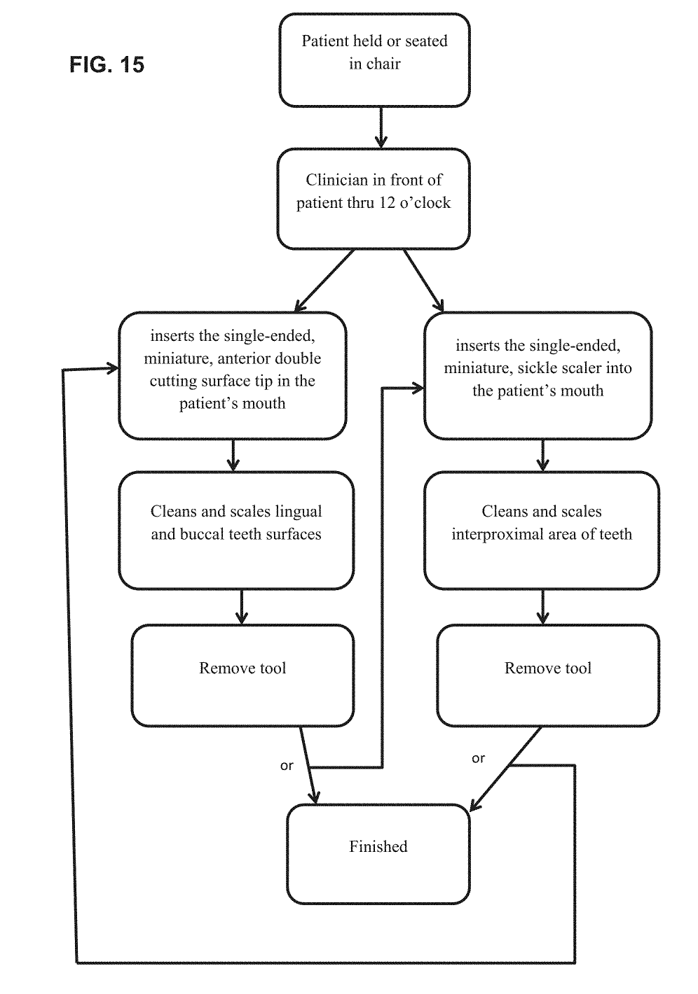

In the preferred method of use summarized in FIG. 15, a dental professional is in front of the patient at about a 6 o'clock position and can treat the patient through any number of angles through the 12 o'clock position. The patient, depending on age, size and ability to remain still, could be seated in a dental chair or held by a second person with the patient or the patient's head resting in the clinician's lap. The clinician examines the patient's teeth and checks for build up of plaque or tartar. Depending on the needs of the patient, the dental professional inserts the single-ended instrument—either the first tool 1, the miniature, anterior double cutting surface or the second tool 2, the miniature, sickle scaler into the patient's mouth to begin cleaning the surfaces of the teeth.

Through the methods of using the first tool 1, a single-ended, miniature, anterior double cutting surface tip, the clinician begins cleaning or scaling the buccal surfaces, also known as the facial surfaces, of the teeth then, without flipping the instrument or changing positions, proceeds directly to scaling the lingual surfaces, also known as the tongue surfaces. The shank of the instrument is kept parallel to the tooth surface (axis) and the mini rounded toe 103 adapts safely and easily to the buccals and linguals of primary teeth. The blade 10 has two cutting surfaces on each side of the blade which allows the dental professional to quickly move from one tooth to another with little movement. The double cutting surface makes it possible to scale both the linguals and buccals of all the patient's primary teeth, including maxillary (upper jaw) and mandibular (lower jaw). Once all the teeth have been cleaned or scaled, the clinician removes the instrument from the patient's mouth or the steps are repeated as necessary and depending on the infant or young child's temperament.

A patient may require further treatment using the second tool 2, a single-ended, miniature sickle scaler to clean the area between the two adjoining teeth. These areas are commonly referred to as the interproximal areas. The clinician inserts the instrument into the patient's mouth, scaling the interproximal space between the mesial and distal surfaces of the teeth with minimal or no changes to the fulcrum of the instrument. This short blade allows the dental professional to work quickly in tight contact areas.

The advantages of using single-ended instruments are that with only one sharp end to the dental hygiene instrument the infant or child cannot grab the instrument and get hurt. The person holding the infant or child will not get hurt by accidentally having the instrument too close to their face. The clinician does not have to worry about someone being harmed from a sharp protrusion from the second end of the instrument and can focus on cleaning the patient's teeth as quickly as possible. Additionally, the single blade can be used on all surfaces of the teeth and does not require the clinician to constantly rotate the instrument or move to another instrument. This is another time saving benefit which is essential for young patients.

The clinician will realize additional advantages of using a miniature, anterior double cutting surface tip with XP Technology or stainless steel (SS) for infants and young children. The mini, anterior double cutting surface tip has two cutting edges allowing the clinician to scale both linguals and facials/buccals while staying in one position. The clinician can scale both lingual and facials/buccals of an infants teeth from the front whether the infant is sitting on a person's lap or a young child is in the chair. The clinician can scale both lingual and facials/buccals of a young child's teeth while sitting in the 12 o'clock position. There is no need to take the time to keep changing positions. The blade of the mini, anterior double cutting surface tip is smaller than the standard blade and fits perfectly on a primary tooth. The blade of the mini, anterior double cutting surface tip has a small rounded toe designed to be gentle on gingival tissue. The combination of the miniature rounded toe and two cutting edges allows for easy adaptation on primary teeth. Because of the small rounded toe and two cutting edges the clinician does not have to change positions and therefore can be very quick when needed for infants and young children. The small rounded toe of the mini, anterior double cutting surface tip adapts to almost all surfaces, especially linguals and facials/buccals.

In use, the mini, single-ended, anterior double cutting surface tip can be used either while working from the front of the infant or young child or through any angle up to the crown of the child's head (the 12 o'clock position) or at any angle that works better for the clinician or the patient and from either side of the patient. Either side of the blade of the single ended, mini, double cutting surface tip can be used to scale linguals or facials/buccals of the teeth. If scaling the linguals of the mandibular anterior teeth, either side of the blade can be used. If scaling the facials/buccals of the mandibular anterior teeth, either side of the blade can be used. Once a clinician starts to scale they can immediately scale the facials/buccals and then without flipping the instrument or changing positions, the clinician can scale the linguals. Since both sides of the instrument blade can be used to scale the primary teeth, it makes for faster scaling. There is no flipping when using this single ended dental hygiene instrument. The simplicity of the dual cutting edges is that the clinician has the flexibility to scale the teeth in all of those positions. Clinician may be seated in front of patient (6 o'clock position) or behind (12 o'clock) or any angle that works best for the operator and the patient. The mini rounded toe 103 adapts safely and easily to the facials/buccals and linguals of primary teeth, allows the clinician to stay in one ergonomic position during scaling without shifting positions, and allows clinicians to keep lower shank parallel to tooth surface (axis), similar to traditional Gracey instrumentation but in the unique manner disclosed herein. Since both sides of the blade have cutting edges, the clinician can easily move from tooth to tooth with very little movement. This allows the clinician to act quickly while scaling an infant's and young child's teeth. The clinician can scale all mandibular anterior primary teeth both facial and lingual while never having to remove or change instruments. The clinician scales all maxillary anterior primary teeth both facial and lingual while never having to remove or change instruments. The size of the mini, anterior double cutting surface tip blade works for all primary teeth. The instrument is useful for all children with primary teeth. The preferred working tip of the anterior double cutting surface tip, works great in these areas. Scaling posterior teeth in infants and young children is similar to scaling anterior primary teeth with this unique miniature, single-ended, double cutting surface tip. Using the mini, anterior, double cutting surface tip, scaling for all posterior primary teeth is completed by moving the instrument from tooth to tooth with little change in angulation. Since primary teeth are smaller and many have open contacts, the mini, anterior double cutting surface tip is useful to scale all surfaces of the tooth including mesial, distals, linguals, and facials/buccals. The clinician fulcrums on one tooth and scales linguals, facials, mesials and distals without changing his or her fulcrum. One preferred sickle scaler will be similar to a Jacquette and particularly a Jacquette #3.

In use, the preferred working tip of the second tool 2 or single-ended, miniature, anterior sickle scaler can be used either while working from the front of the infant or young child or at any angle up to the 12 o'clock position, and from either side of the patient. Either side of the small short blade can be used to scale interproximal areas of primary teeth. The small blade can be used to scale interproximal from the lingual and facial/buccal areas, and allows the clinician to also scale between mesial and distal surfaces even though the instrument is single-ended. The clinician can fulcrum on one tooth and be able to scale mesials and distals without changing his or her fulcrum. The shortened small blade can be used quickly in tight contact areas of the mandibular or maxillary anterior or posterior areas. Posterior teeth in infants and young children is easy to access and the mini, anterior, scaler works great in these areas. The size of the mini, anterior, scaler blade of the present invention works for all primary teeth. The instrument is useful for all children with primary teeth. The clinician scales all maxillary anterior primary teeth both mesial and distal while never having to remove or change instruments. There is no flipping of a single ended dental hygiene instrument so it makes for faster scaling which is needed for infants and young children. The safety aspect of the single ended instrument is mandatory for infants and young children.

It is further intended that any other embodiments of the present invention which result from any changes in application or method of use or operation, method of manufacture, shape, size, or material which are not specified within the detailed written description or illustrations contained herein, yet are considered apparent or obvious to one skilled in the art, are within the scope of the present invention.

1. A set of pediatric dental cleaning instruments comprising:
a first instrument having a miniature anterior double gracey cutting surface tip, and
a second instrument having a miniature scaler,
the first instrument and the second instrument each having a single, working end receiving a shortened blade, the first instrument and second instrument each further having a single, blunt-ended handle.

2. The miniature, anterior double cutting surface tip of claim 1 further comprising:
a mini rounded toe,
two cutting edges each terminating at the toe.

3. The miniature scaler of claim 1, wherein the instrument further comprises:
an anterior sickle scaler.

4. A method whereby a clinician cleans teeth in a pediatric patient mouth using the set of pediatric dental cleaning instruments of claim 1, the method comprising:
positioning a pediatric patient in repose,
assuming a position in proximity to the pediatric patient mouth,
examining the teeth and checking for build up of plaque or tartar,
selecting one of the instruments to clean the teeth,
inserting the instrument into the pediatric patient mouth, and
cleaning the teeth
removing the instrument from the pediatric patient mouth.

5. The method of claim 4 wherein the positioning of a pediatric patient is in a dental chair.

6. The method of claim 4 wherein the positioning of a pediatric patient is with a caregiver allowing the pediatric patient's head to rest in the clinician's lap.

7. The method of claim 4 wherein the clinician may be assuming a position through any number of angles from 6 o'clock through 12 o'clock in proximity to the pediatric patient mouth.

8. The method of claim 4 wherein when selecting one of the instruments the clinician selects the miniature, anterior double cutting surface tip, and continues with the method, the cleaning further comprising:
scaling buccal surfaces of the teeth,
proceeding directly to scaling lingual surfaces without flipping the single-ended, miniature, anterior double cutting surface tip or changing positions,
keeping the single-ended, miniature, anterior double cutting surface tip parallel to the tooth surface,
completing the scaling,
removing the instrument from the pediatric patient mouth

9. The method of claim 8, wherein the clinician repeats the method as necessary.

10. The method of claim 4, wherein when selecting one of the instruments the clinician selects the miniature scaler and continues with the method, the cleaning further comprising:
inserting the miniature scaler into the pediatric patient mouth
cleaning interproximal surfaces between mesial and distal surfaces of the teeth with minimal or no changes to fulcrum of the instrument.

11. The method of claim 10, wherein the clinician repeats the method as necessary.

12. A preventative, pediatric tooth decay treatment comprising:
using a set of single-ended, miniature dental instruments for treating one or more teeth in a pediatric patient mouth,
positioning a pediatric patient in repose,
assuming a position in proximity to the pediatric patient mouth,
examining the teeth and checking for build up of plaque or tartar,
selecting a first tool from the set of single-ended, miniature dental instruments,
inserting the first tool into the pediatric patient mouth,
scaling buccal surfaces of the teeth,
proceeding directly to scaling lingual surfaces without flipping the first tool or changing positions,
keeping the first tool parallel to a tooth surface,
completing the scaling,
removing the first tool from the pediatric patient mouth,
selecting a second tool from the set of single-ended, miniature dental instruments,
inserting the second tool into the pediatric patient mouth,
cleaning interproximal surfaces between mesial and distal surfaces of the teeth with minimal or no changes to fulcrum of the instrument,
removing the second tool from the pediatric patient mouth,
repeating portions of the treatment as necessary.

13. The set of single-ended, miniature dental instruments of claim 12 further comprising an anterior double cutting surface tip and an anterior scaler.

14. The set of single-ended, miniature dental instruments of claim 12 wherein the first tool further comprises an anterior double cutting surface tip.

15. The set of single-ended, miniature dental instruments of claim 12 wherein the second tool further comprises an anterior scaler.

16. An improved technique for pediatric dental care by a clinician comprising:
using at least one single-ended, miniature dental instrument,
positioning a pediatric patient in repose,
assuming a position in proximity to a pediatric patient mouth,
examining teeth and checking for build up of plaque or tartar,
inserting the single-ended, miniature dental instrument into the pediatric patient mouth,
scaling buccal surfaces of the teeth,
proceeding directly to scaling lingual surfaces without flipping the single-ended, miniature, dental instrument or changing positions,
keeping the single-ended, miniature, dental instrument parallel to the tooth surface,
completing the scaling,
cleaning interproximal surfaces between mesial and distal surfaces of the teeth with minimal or no changes to fulcrum of the instrument,
removing the single-ended, miniature dental instrument from the pediatric patient mouth,
repeating portions of the treatment as necessary.

17. The single-ended, miniature dental instrument of claim 16 comprising at least one anterior double cutting surface tip.

18. The single-ended, miniature dental instrument of claim 16 comprising at least one an anterior scaler.

19. The single-ended, miniature dental instrument of claim 16 comprising an anterior double cutting surface tip and an anterior scaler.

20. The treatment of claim 19 wherein the anterior double cutting surface tip is used for scaling buccal and lingual surfaces and the anterior scaler is used for cleaning interproximal surfaces between mesial and distal surfaces of the teeth.
